(19) United States
(12) Patent Application Publication
(10) Pub. No.: US 2025/0188201 A1
(43) Pub. Date: Jun. 12, 2025

(54) CATALYST FOR PHOTOCATALYTIC POLYMERIZATION REACTION, AND APPLICATION THEREOF

(71) Applicant: BEIJING INSTITUTE OF FASHION TECHNOLOGY, Beijing (CN)

(72) Inventors: Jiguang LIU, Beijing (CN); Ruxiu WANG, Beijing (CN); Yafei YANG, Beijing (CN); Shiping HAN, Beijing (CN)

(21) Appl. No.: 18/845,913

(22) PCT Filed: Mar. 10, 2023
(86) PCT No.: PCT/CN2023/080837

§ 371 Date: Sep. 11, 2024

(30) Foreign Application Priority Data
Mar. 11, 2022 (CN) 202210239605.0

(51) Int. Cl. C08F 4/78; C08F 4/80; C08F 110/02; C08F 112/08; C08F 120/14

(52) U.S. Cl. CPC C08F 4/78; C08F 4/80; C08F 110/02; C08F 112/08; C08F 120/14

(57) ABSTRACT

Organic-inorganic composite catalyst particles for a photocatalytic polymerization reaction, and an application thereof are provided. The organic-inorganic composite catalyst includes an organic part and an inorganic part, the inorganic part being dispersed on the surface and/or inside the organic part in the form of inorganic particles, the size of the inorganic particles being less than 100 μm. Also provided are a method for performing a photocatalytic polymerization reaction under the catalysis of the catalyst, and a product obtained thereby. The organic-inorganic composite catalyst is used for a photocatalytic polymerization reaction during a polymerization reaction process, and can be suitable for polymerization of most olefins. A polymer prepared by means of the excitation polymerization reaction can be used in multiple fields such as color-changing fibers, color-changing sheets and color-changing inks, and anti-counterfeiting and camouflage.

The present application claims priority to the prior application with the patent application No. 202210239605.0, entitled “CATALYST FOR PHOTOCATALYTIC POLYMERIZATION REACTION, AND APPLICATION THEREOF” and filed with China National Intellectual Property Administration on Mar. 11, 2022, the content of which is incorporated herein by reference in its entirety.

### TECHNICAL FIELD

The present disclosure belongs to the field of catalytic polymerization and relates to a catalyst for photoexcited catalytic polymerization and use thereof and particularly to a photoexcited polymerization reaction catalyzed by bi-component catalyst particles of an organic component and an inorganic component and a polymer obtained therefrom.

### BACKGROUND

In the field of materials chemistry, the study of catalysts and their catalytic processes has long been a focal point of research. The current development trends in the fields of polymerization reactions primarily include free-radical polymerization, coordination polymerization, cationic polymerization, anionic polymerization, etc. Typically, these polymerization reactions require catalysts or initiators. However, to date, only a limited number of initiators or catalysts are available, each of which is only suitable for the polymerization of a limited number of olefin monomers with its own limitations. For example, coordination polymerization catalysts are widely used in olefin polymerization but generally require high-pressure conditions and are prone to deactivation and thus are difficult to be stored. Anionic initiators often require stringent anhydrous and oxygen-free conditions to initiate polymerization.

In recent years, a class of controllable photocatalytic polymerization reactions has garnered attention.

Photocatalytic polymerization has significant advantages of low reaction temperatures, easy control, etc., making it particularly attractive. However, research on this type of catalytic reaction is limited and is now still in its early stages. For example, Jiangtao Xu et al. used RAFT and iridium-based composite catalysts for photoinduced living polymerization, achieving polymerization of various olefin monomers such as methyl methacrylate, styrene, etc., but with low yields (non-patent document 1: J. Am. Chem. Soc. 2014, 136, 14, 5508-5519). Additionally, Alex Stafford et al. used methyne and aza-modified boron dipyrromethene for the polymerization of isobornyl acrylate. Although very high double bond conversion rates were achieved, data on molecular weight and molecular weight distribution were not provided (non-patent document 2: J. Am. Chem. Soc. 2020, 142, 34, 14733-14742). Qiang Ma et al. used oxygen-doped anthanthrene photocatalysts for the living polymerization of methyl methacrylate. Although relatively good catalytic activity can be achieved, the molecular weights are generally relatively low (non-patent document 3: NATURE COMMUNICATIONS|(2021) 12:429). Bonnie L. Buss et al. used organocatalyzed atom free-radical polymerization for acrylate monomers, though the molecular weights were relatively low (non-patent document 4: Angew. Chem. 2020, 132, 3235-3243). Lei Xia et al. successfully conducted visible-light-driven, controllable living polymerization reactions of acrylate and acrylamide monomers using poly(1,4-diphenylbutadiyne) as a catalyst and water-soluble trithiocarbonate as a chain transfer agent (non-patent document 5: Adv. Sci. 2020, 7, 1902451).

However, most reported photocatalytic polymerization reactions only apply to a limited number of olefin monomers due to the performance constraints of the catalysts. Moreover, to date, reports on large-scale industrial photocatalytic polymerization are rare due to the complicated synthesis, high cost, poor stability, etc. of photocatalysts. Therefore, there is a need for a photoexcitation catalyst (photocatalyst) that is simple to synthesize and inexpensive and is thus capable of realizing the controllable mass preparation of polymers.

### DOCUMENTS OF THE PRIOR ART

### Non-Patent Documents

Non-patent document 1: Jiangtao Xu†‡, Kenward Jung†, Amir Atme‡, Sivaprakash Shanmugam†, and Cyrille Boyer, A Robust and Versatile Photoinduced Living Polymerization of Conjugated and Unconjugated Monomers and Its Oxygen Tolerance, J. Am. Chem. Soc. 2014, 136, 14, 5508-5519 Non-patent document 2: Alex Stafford, Dowon Ahn, Emily K. Raulerson, Kun-You Chung, Kaihong Sun, Danielle M. Cadena, Elena M. Forrister, Shane R. Yost, Sean T. Roberts, and Zachariah A. Page, Catalyst Halogenation Enables Rapid and Efficient Polymerizations with Visible to Far-Red Light, J. Am. Chem. Soc. 2020, 142, 34, 14733-14742
Non-patent document 3: Qiang Mal, Jinshuai Song 2, Xun Zhang1, Yu Jiang1, Li Ji3 & Saihu Liao, Metal-free atom transfer radical polymerization with ppm catalyst loading under sunlight, NATURE COMMUNICATIONS|(2021) 12:429.
Non-patent document 4: Bonnie L. Buss, Chern-Hooi Lim und Garret M. Miyake, Dimethyl Dihydroacridines as Photocatalysts in Organocatalyzed Atom Transfer Radical Polymerization of Acrylate Monomers, Angew. Chem. 2020, 132, 3235-3243
Non-patent document 5: Lei Xia, Bo-Fei Cheng, Tian-You Zeng, Xuan Nie, Guang Chen, Ze Zhang, Wen-Jian Zhang, Chun-Yan Hong, Ye-Zi You, Polymer Nanofibers Exhibiting Remarkable Activity in Driving the Living Polymerization under Visible Light and Reusability, Adv. Sci. 2020, 7, 1902451.

### SUMMARY

To solve the problems described above, the present disclosure provides an organic-inorganic composite catalyst, thereby overcoming the bottleneck in catalytic polymerization technology. In addition, the present disclosure enables the controllable mass preparation of polymers through a corresponding process, and a polymerization product with specific properties is prepared. Further, the present disclosure provides a photoexcited polymerization reaction (photocatalytic polymerization reaction) catalyzed by the catalyst of the present disclosure, and a polymerization product obtained therefrom.

Specifically, the present disclosure provides the following technical solutions:

a method for conducting a photoexcited catalytic polymerization reaction catalyzed by an organic-inorganic composite catalyst, comprising the following steps: dispersing the organic-inorganic composite catalyst in an olefin monomer, and conducting a polymerization reaction of the olefin monomer under photoexcitation conditions, wherein the organic-inorganic composite catalyst comprises an organic portion and an inorganic portion, wherein the inorganic portion is dispersed in the form of inorganic particles on the surface of and/or inside the organic portion, and the inorganic particles have a size of not more than 100 μm.

The present disclosure further provides a polymer obtained using the method described above.

The present disclosure further provides use of the polymer described above in color-changing fibers, color-changing sheets, color-changing membranes, color-changing inks, color-changing toners, color-changing adhesives, color-changing energy-saving windows, camouflage, and anti-counterfeiting.

The present disclosure further provides an organic-inorganic composite catalyst comprising an organic portion and an inorganic portion, wherein the inorganic portion is dispersed in the form of inorganic particles on the surface of and/or inside the organic portion, and the inorganic particles have a size of not more than 100 μm.

The present disclosure further provides a supported catalyst comprising a support and the organic-inorganic composite catalyst described above on the support.

The present disclosure further provides use of the organic-inorganic composite catalyst and/or the supported catalyst described above in a photocatalytic polymerization reaction, particularly in a photocatalytic living polymerization reaction.

Beneficial effects of the present disclosure:

Since a photoexcitation source is used in the polymerization reaction of the present disclosure to control the polymerization, the polymerization reaction has the characteristics of a controllable reaction. This provides a new pathway and new means for switchable catalysis and controllable polymerization, marking a creative breakthrough in the development of novel intelligent materials. The use of particles as a catalyst allows the catalyst to be separated and reused after the reaction, which helps significantly reduce catalyst costs. Since the polymerization reaction can be conducted at room temperature, it is not only energy-efficient but also simplifies the equipment and reduces reaction difficulty in the polymerization process, making it particularly suitable and beneficial for large-scale industrial production. Therefore, this reaction mode has important application value.

Furthermore, due to the special catalyst in this polymerization reaction, the resulting polymer possesses distinctive properties, such as controllable molecular weight distribution and a color-changing property, offering a new polymer variety for industrial products. The polymer prepared by this method can be used in sheets, polymer membrane materials, coating materials, adhesives, sealants, toners, organic glass, etc., especially in color-changing coating materials, color-changing inks, color-changing toners, color-changing adhesives, color-changing mucilages, color-changing membranes, etc., and thus has wide application.

Moreover, the present disclosure provides a supported catalyst. Since supported hybrid particles are used as the catalyst, the supported catalyst is easy to be recovered after reactions and is highly suitable for being reused, which helps greatly reduce catalyst costs. Polymers prepared with this supported catalyst possess unique properties, such as controllable molecular weight distribution and higher molecular weights (for example, ultra-high molecular weights up to over a million).

### BRIEF DESCRIPTION OF THE DRAWINGS

FIG. 1 is a scanning electron micrograph of the catalyst particles prepared in Example 1.

FIG. 2 is a transmission electron micrograph of the catalyst particles prepared in Example 4.

FIG. 3 is a scanning electron micrograph of the catalyst particles prepared in Example 5.

FIG. 4 is a scanning electron micrograph of the supported catalyst prepared in Example 5A.

FIG. 5 is a nuclear magnetic resonance spectrum of Example 14.

FIG. 6 is an infrared spectrum of Example 17.

FIG. 7 is a nuclear magnetic resonance spectrum of Example 22.

FIG. 8 is a molecular weight distribution curve of Example 22.

FIG. 9 is a molecular weight distribution curve of Example 25.

FIG. 10 shows a comparison of the polymer of Example 25 before and after a color change, wherein the upper graph shows the polymer before the color change, and the lower graph shows the polymer after the color change.

FIG. 11 shows the molecular weight distribution of polymethyl methacrylate prepared using the supported catalyst.

### DETAILED DESCRIPTION

### [Organic-Inorganic Composite Catalyst]

As described above, the present disclosure provides an organic-inorganic composite catalyst comprising an organic portion and an inorganic portion, wherein the inorganic portion is dispersed in the form of inorganic particles on the surface of and/or inside the organic portion, and the inorganic particles have a size of not more than 100 μm.

According to an embodiment of the present disclosure, the size of the inorganic particles is less than the volume of the organic portion.

According to an embodiment of the present disclosure, the size of the inorganic particles is preferably not more than 10 μm, more preferably not more than 5 μm, and further preferably greater than 0 nm and not more than 0.1 μm.

According to an embodiment of the present disclosure, an ingredient of the organic portion is selected from, for example, a polymer, including, but not limited to: a homopolymer of an olefin monomer containing an acylamino group, a hydroxyl group, a carboxyl group, or an ester group; a copolymer of two or more olefin monomers containing an acylamino group, a hydroxyl group, a carboxyl group, or an ester group; or a cross-linked polymer formed from no less than one olefin monomer containing an acylamino group, a hydroxyl group, a carboxyl group, or an ester group and a cross-linking agent; or a copolymer of no less than one olefin monomer containing an acylamino group, a hydroxyl group, a carboxyl group, or an ester group with an additional monomer; or derivatives obtained by further reacting the polymers described above.

According to an embodiment of the present disclosure, the olefin monomer containing an acylamino group includes, but is not limited to, at least one of the monomers represented by formula 1 or formula 2 below:

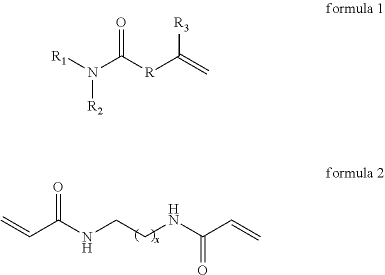

wherein in formula 1, R is CₙH₂ₙ (n is an integer greater than or equal to 0, preferably 0 to 28); R₁, R₂, and R₃ are identical or different and are each independently R₄—CₘH₂ₘ (wherein m is an integer greater than or equal to 0, preferably 0 to 16), and R₄ may be absent or H, amino, an amine group, carboxyl, halogen, OR₅ [R₅ is H, C_{m′}H_{2m′+1} (m′=1-18), C_{m″}H_{2m″} (m″=1-18), or C_{m′″}H_{2m′″-1} (m′″=1-18)], NR₆R₇ [R₆ and R₇ are identical or different and are each independently H, C_{n′}H_{2n′+1} (n′=1-18), C_{n″}H_{2n″} (n″=1-18), or C_{n′″}H_{2n′″-1} (n′″=1-18)], phenyl, phenylhydroxyl, styryl, naphthyl, C₃₋₁₈ cycloalky (wherein C₃₋₁₈ cycloalky is preferably cyclopropyl, cyclobutyl, cyclopentyl, or cyclohexyl), C₃₋₁₂ cycloalkenyl (preferably cyclopropenyl, cyclobutenyl, cyclopentenyl, cyclopentadienyl, cyclohexenyl, cyclohexadienyl, cycloheptenyl, or cyclooctenyl), pyrrolidinyl, or

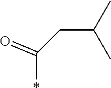 [SMILES: *C(=O)CC(C)C]

(* represents a point of attachment); and
in formula 2, x is an integer greater than or equal to 0, preferably 0 to 28.

It should be noted that in the present disclosure, “amino” refers to —NH₂, and “amine group” refers to a group in which at least one H atom in —NH₂ is substituted with alkyl.

According to an embodiment of the present disclosure, the olefin monomer containing acylamino particularly includes acrylamide and derivatives thereof, butenamide and derivatives thereof, pentenamide and derivatives thereof, pentadienamide and derivatives thereof, and hexenamide and derivatives thereof.

It should be noted that in the present disclosure, “derivative” refers to a compound obtained by substituting a hydrogen atom with a substituent, and the substituent can be a common substituent in the art, for example, alkyl, hydroxyl, amino, alkoxy, or the like.

Specifically, the olefin monomer containing acylamino is preferably selected from at least one of acrylamide, methacrylamide, N,N-dimethylacrylamide, N-methylolacrylamide, N-ethylacrylamide, N,N-diethylacrylamide, N-ethyl-2-methacrylamide, N-n-propylacrylamide, N-(3-methoxypropyl)acrylamide, N-isopropylacrylamide, N-isopropylmethacrylamide, cyclopropylmethacrylamide, N-[(3-dimethylamino)propyl]acrylamide, dimethylaminopropylmethacrylamide, N-butylacrylamide, N-isobutylacrylamide, N-(1,1-dimethyl-3-oxobutyl)acrylamide, N-tert-butylacrylamide, N-butoxymethacrylamide, N-(isobutoxymethyl)acrylamide, N,N-dibutylacrylamide, 4-hydroxybutylacrylamide, N-pentylacrylamide, cyclopentylacrylamide, N-n-hexylacrylamide, N-hexylhydroxamic acid acrylamide, N-cyclohexylacrylamide, N-n-octylacrylamide, N-tert-octylacrylamide, N-dodecylacrylamide, N,N′-methylenebisacrylamide, N,N′-(1,2-dihydroxyethylene)bisacrylamide, N,N-bis(2-hydroxyethyl)methacrylamide, N-(2-hydroxypropyl)methacrylamide, 2-methyl-N-(2-phenylethyl)-2-acrylamide, N-(p-hydroxyphenyl)methacrylamide, N-cyclopropylmethacrylamide, N-pyrrolidinylacrylamide, α-bromoacrylamide, N,N-diglycidylacrylamide, N,N-diglycidylmethacrylamide, N-(4-epoxypropoxybutyl)acrylamide, N-(4-epoxypropoxybutyl)methacrylamide, N-(5-epoxypropoxypentyl)acrylamide, butenamide, N-tert-butylbutenamide, N-ethyl-N-(2-methylphenyl)-2-butenamide, (2E)-2-butenamide, 4-methyl-2-pentenamide, N-benzyl-4-chloro-N-isobutyl-2-pentenamide, N-methoxy-4-pentenamide, N-ethoxy-4-pentenamide, N-propoxy-4-pentenamide, N-butoxy-4-pentenamide, (2S,4E)-5-chloro-N,N-dimethyl-2-isopropyl-4-pentenamide, N-ethyl E2,E4-hexadienamide, N-cyclopropyl E2,E4-hexadienamide, 3,7-dimethyl-2,6-octadienamide, 3-butenamide, fluorobutenamide, and N-(1-naphthyl)acrylamide.

According to an embodiment of the present disclosure, the olefin monomer containing carboxyl includes, but is not limited to, at least one of the monomers represented by formula 3 or formula 4 below:

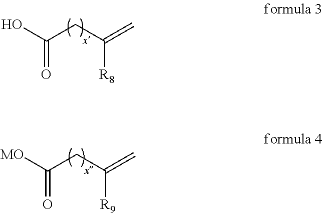

wherein x′ and x″ are each independently an integer greater than or equal to 0, preferably 0 to 18; R₈ and R₉ are identical or different and are each independently R′—C_{y′}H_{2y′} or R′—C_{y″}H_{2y″-1} (R′ is absent or H, OH, COOH, C₃₋₁₈ cycloalkyl, C₃₋₁₂ alkoxy, phenyl, or C₃₋₁₂ cycloalkenyl; y′ is an integer greater than or equal to 0, preferably 0 to 18, and y″ is an integer greater than or equal to 0, preferably 1 to 18); and
M is a metal ion, particularly an ion of Na, K, Li, Ca, Mg, Fe, Al, Zn, Ni, Co, Cu, or the like.

According to an embodiment of the present disclosure, the olefin monomer containing carboxyl is particularly preferably selected from at least one of acrylic acid, methacrylic acid, ethylacrylic acid, propylacrylic acid, 4-hydroxybutylacrylic acid, allylmalonic acid, 2-acetamidoacrylic acid, or corresponding salts thereof (e.g., sodium acrylate, potassium acrylate, lithium acrylate, ammonium methacrylate, sodium methacrylate, potassium methacrylate, lithium methacrylate, and sodium ethylacrylate).

The olefin monomer containing hydroxyl is selected from hydroxyethyl acrylamide, N-(2-hydroxypropyl)acrylamide, 4-hydroxybutyl acrylate, 2-hydroxypropyl acrylate, 5-hydroxypentyl acrylate, pentaerythritol triacrylate, 2-hydroxyethyl acrylate, hydroxydiacrylate, hydroxyoctyl acrylate, N-hydroxyethyl perfluorooctanamide acrylate, methyl DL-2-hydroxy-3-butenoate, 3-hydroxybutenoic acid-β lactone, (z)-4-hydroxy-2-pentenoate, tert-butyl 3-hydroxy-4-pentenoate, ethyl 3-hydroxy-4-pentenoate, 2,3,4,5,6-pentahydroxy-2-hexenoic acid-4-lactone, ethyl (2e)-5-hydroxy-2-pentenoate, 2-hydroxy-4-pentenoic acid, acrylamide-polyethylene glycol-hydroxyl, ethylene glycol diacrylate, tetraethylene glycol diacrylate, poly(ethylene glycol) methacrylate, poly(ethylene glycol) methyl ether acrylate, and phthalate diethylene glycol diacrylate.

According to an embodiment of the present disclosure, the olefin monomer containing an ester group includes, but is not limited to, at least one of the monomers represented by formula 5, formula 6, or formula 7 below:

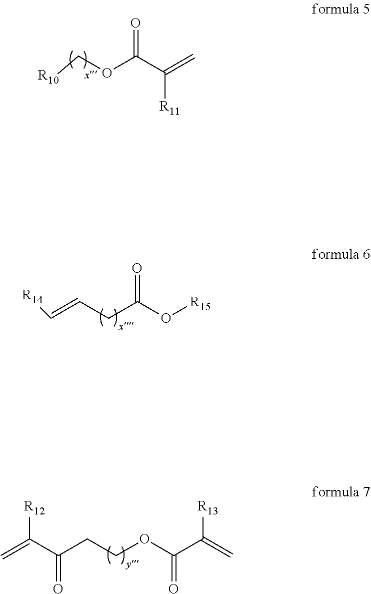

wherein x′″ and x″″ are each independently an integer greater than or equal to 0, preferably 0-18; y′″ is an integer greater than 0, preferably 1 to 18;
R₁₀, R₁₁, R₁₂, R₁₃, R₁₄, and R₁₅ are identical or different and are each independently R″—C_{z}H_{2z+1}, R″—C_{z′}H_{2z′}, or R″—C_{z″}H_{2z″-1}, wherein z and z′ are each independently an integer greater than or equal to 0, preferably 0 to 18; z″ is an integer greater than or equal to 1, preferably 1 to 18; R″ is absent or H, OH, amino, carboxyl, C₃₋₁₂ alkoxy, an amine group, phenyl, phenylhydroxyl, styryl, C₃₋₈ cycloalkyl (wherein C₃₋₈ cycloalkyl is preferably cyclopropyl, cyclobutyl, cyclopentyl, or cyclohexyl), or C₃₋₁₂ cycloalkenyl (preferably cyclopropenyl, cyclobutenyl, cyclopentenyl, cyclopentadienyl, cyclohexenyl, cyclohexadienyl, cycloheptenyl, or cyclooctenyl).

According to an embodiment of the present disclosure, the olefin monomer containing an ester group particularly includes an olefin monomer containing an acrylate group, a butenoate group, a pentenoate group, or a hexenoate group.

According to an embodiment of the present disclosure, the olefin monomer containing an ester group is particularly preferably selected from at least one of acrylate N-hydroxyethyl acrylamide, 4-hydroxybutyl acrylate, cyclohexyl acrylate, polyethylene glycol monoacrylate, polyethylene glycol diacrylate, ethylene glycol acrylate, ethylene glycol dimethacrylate, triethylene glycol diacrylate, triethylene glycol dimethacrylate, N,N-dimethylaminoethyl methacrylate, glycidyl methacrylate, hydroxyethyl methacrylate, methacrylate ethyl acetoacetate, trimethylolpropane triacrylate, ethylene glycol dimethacrylate, ethylene glycol methacrylate, Ethyl 3-(N,N-dimethylamino) acrylate, hydroxypropyl acrylate, 4-hydroxybutyl acrylate, diethyl allylmalonate, methyl allyldiacetate, methyl allyldiacetate, 4-allylpyrocatechol diacetate, 2-methallyl diacetate, methyl 2-acetamidoacrylate, ethyl 2-acetamidoacrylate, propyl 2-acetamidoacrylate, butyl 2-acetamidoacrylate, phenyl butenoate, hexyl 2-butenoate, propyl 4-pentenoate, ethyl 4-pentenoate, 5-chloro-3-pentenoate, methyl trans-3-pentenoate, methyl 2-hexenoate, methyl 3-hexenoate, ethyl trans-3-hexenoate, and ethyl 4-hexenoate. According to an embodiment of the present disclosure, the cross-linking agent may include the olefin monomers containing at least two double bonds among the monomers described above, such as N,N′-methylenebisacrylamide, trimethylolpropane triacrylate, polyethylene glycol diacrylate, ethylene glycol diacrylate, phthalate diethylene glycol diacrylate, ethylene glycol dimethacrylate, and divinylbenzene. Additionally, the cross-linking agent may also include other olefin monomers containing at least two double bonds in a single molecule, such as 1,5-hexadiene, butadiene, pentadiene, triallyl isocyanurate, and the like.

In forming a cross-linked polymer with a cross-linking agent, the cross-linking agent is added in an amount of 0.01 wt % to 90 wt %, preferably 0.1 wt % to 50 wt %, and more preferably 1 wt % to 30 wt % based on the total amount of monomers forming the cross-linked polymer.

According to an embodiment of the present disclosure, in the copolymer with an additional monomer, the additional monomer is: for example, an olefin monomer containing phenyl (e.g., styrene, methylstyrene, or ethylstyrene), vinylpyridine, thiophene and derivatives thereof, pyrrole and derivatives thereof, aniline and derivatives thereof, divinylbenzene, N,N-diethenylethenamine, 2-octen-4,6-diynamide, alginic acid and salts thereof (e.g., sodium alginate and potassium alginate), polyethylene glycol, polyvinyl acetate, polyvinyl alcohol, cellulose and derivatives thereof (e.g., sodium carboxymethylcellulose, carboxymethylcellulose, and ethylcellulose), cyclodextrin and cross-linked polymers thereof, chitosan and derivatives thereof, or chitin and derivatives thereof.

When an additional monomer is contained, the additional monomer is added in an amount of 0.01 wt % to 95 wt %, preferably 0.1 wt % to 50 wt %, and more preferably 1 wt % to 30 wt % based on the total amount of monomers forming the copolymer.

According to an embodiment of the present disclosure, the polymer further includes a polymer derivative obtained by further reacting the polymer described above, such as a sulfonation product obtained from a sulfonation reaction, a hydrolysis product obtained from a hydrolysis reaction, or the like, for example: poly(acrylamide-styrene sulfonate) obtained from a sulfonation reaction of poly(acrylamide-styrene); the hydrolysis product of polyvinyl alcohol, polyvinyl acetal, or other polyvinyl alcohol cross-linking products obtained from a hydrolysis reaction of polyvinyl acetate.

According to an embodiment of the present disclosure, an ingredient of the inorganic portion in the catalyst of the present disclosure is selected from, for example, inorganic substances containing a metal element, wherein the metal element includes at least a metal element having a variable valence characteristic, for example, at least one metal selected from tungsten, molybdenum, scandium, rhodium, vanadium, aluminum, manganese, iridium, osmium, ruthenium, europium, terbium, cerium, yttrium, and uranium. Additionally, the metal element may also include at least one element selected from chromium, zinc, cadmium, phosphorus, sulfur, neodymium, thorium, strontium, gallium, indium, and the like.

According to an embodiment of the present disclosure, the inorganic substance is at least one of an oxide, a sulfide, a hydroxide, a sulfate, a carbonate, and an oxometallic acid or a salt thereof of the metal element described above; or a metal compound insoluble in water and organic solvents, obtained by converting a soluble metal compound, for example: zinc sulfide particles obtained by adding sodium sulfide to water containing zinc chloride, tungstic acid precipitate and/or tungsten oxide obtained by adding an acid to an aqueous sodium tungstate solution, ferric hydroxide and/or ferric oxide obtained by adding sodium hydroxide to an aqueous solution of ferric chloride, and the like. Specifically, the inorganic substance is selected from at least one of tungsten oxide, molybdenum oxide, scandium oxide, rhodium oxide, uranium oxide, ferric chloride, ferroferric oxide, rhodium hydroxide, aluminum oxide, aluminum hydroxide, vanadium hydroxide, vanadium oxide (e.g., divanadium pentaoxide, vanadium trioxide, or vanadium dioxide), discandium trioxide, scandium hydroxide, and yttrium orthovanadate, or may also be selected from at least one of ferric oxide, zinc oxide, manganese oxide, cadmium sulfide, cerium sulfide, vanadium sulfate, tungstic acid, sodium tungstate, potassium tungstate, lithium tungstate, ammonium tungstate, aluminum tungstate, chromium tungstate, metatungstic acid, lithium metatungstate, sodium metatungstate, potassium metatungstate, ammonium metatungstate, molybdic acid, sodium molybdate, phosphotungstic acid, cesium phosphotungstate, phosphomolybdic acid, cesium phosphomolybdate, potassium molybdate, lithium molybdate, sodium molybdate, ammonium molybdate, aluminum molybdate, chromium molybdate, molybdic acid, metamolybdic acid, lithium metamolybdate, sodium metamolybdate, potassium metamolybdate, ammonium metamolybdate, potassium chromate, sodium chromate, lithium chromate, potassium dichromate, sodium dichromate, potassium permanganate, sodium permanganate, lithium permanganate, vanadium oxide, ammonium vanadate, sodium vanadate, potassium vanadate, lithium vanadate, magnesium vanadate, calcium vanadate, iron vanadate, yttrium vanadate, neodymium-doped yttrium vanadate, GaN, InN, InGaN, and the like.

According to an embodiment of the present disclosure, an ingredient of the inorganic portion in the organic-inorganic composite catalyst may further contain other inorganic components or adjuvants, such as: titanium dioxide, silica, sodium oxide, potassium oxide, magnesium oxide, diantimony trioxide, barium sulfate, zirconium oxide, calcium carbonate, magnesium carbonate, strontium carbonate, magnesium hydroxide, ferric hydroxide, hydrochloric acid, sulfuric acid, nitric acid, phosphoric acid, oxalic acid, formic acid, acetic acid, citric acid, lauric acid, and the like. According to an embodiment of the present disclosure, the mass ratio of the organic portion to the inorganic portion can be 1:100 to 10,000:1, preferably 1:10 to 1000:1, and more preferably 1:1 to 100:1.

According to an embodiment of the present disclosure, the organic-inorganic composite catalyst may have various shapes such as a block shape, an irregular powder shape, a spherical shape, and a porous shape, preferably a spherical shape, and further preferably a spherical, porous shape.

According to an embodiment of the present disclosure, an ingredient of the organic portion may be polymer particles, preferably polymer particles having a certain shape, such as a spherical, oblate, flaky, rod-like, or needle-like shape, preferably a spherical or oblate shape.

According to an embodiment of the present disclosure, the size of the organic-inorganic composite catalyst may be any size, and is generally greater than 0 nm and less than 10 cm; preferably not less than 10 nm and not more than 10 mm; more preferably 50 nm to 100 μm; and further preferably 100 nm to 50 μm.

According to an embodiment of the present disclosure, the organic-inorganic composite catalyst is mainly used for catalyzing polymerization reactions, and can be particularly used for photoexcited catalytic polymerization, especially photoexcited catalytic living polymerization. The photoexcitation is, for example: visible light excitation, ultraviolet light excitation, infrared light excitation, sunlight excitation, X-ray excitation, or the like.

### [Preparation of Organic-Inorganic Composite Catalyst]

As described above, the present disclosure further provides a preparation method for the catalyst described above, comprising the following steps:
dispersing the ingredient of the organic portion in a solvent, adding the ingredient of the inorganic portion, and contacting to give the catalyst; or,
dispersing the ingredient of the organic portion in a solvent, adding the ingredient of the inorganic portion, and adding a precipitant for reaction to give the catalyst; or,
dispersing the monomer ingredient of the organic portion in a solvent, adding the ingredient of the inorganic portion, and then conducting a polymerization reaction to give the catalyst; or, dispersing the monomer ingredient of the organic portion in a solvent, adding the ingredient of the inorganic portion, then conducting a polymerization reaction, and then adding a precipitant for reaction to give the catalyst.

According to an embodiment of the present disclosure, the ingredient of the organic portion may be polymer particles, preferably polymer particles having a certain shape, such as a spherical, oblate, sheet-like, rod-like, or needle-like shape, preferably a spherical or oblate shape. The monomer of the organic portion is the monomer of the aforementioned organic portion. The ingredient of the inorganic portion is selected from an inorganic substance containing a metal element, and may be, for example, a metal salt, a metal salt solution, and/or a soluble metal compound solution.

It should be noted that in the present disclosure, “soluble metal compound” refers to a metal compound, other than metal salts, that is soluble in the solvent.

According to an embodiment of the present disclosure, the solvent may be: water, alcohols, ketones, amides, esters, alkanes, arenes, ionic liquids, and other solvents, specifically, for example, water, ethanol, ethylene glycol, isoprene glycol, propanol, isopropanol, butanol, glycerol, pentanol, hexanol, acetone, butanone, pentanone, dimethylformamide, dimethylacetamide, dimethyl sulfoxide, tetrahydrofuran, ethyl acetate, pyrrolidine, dioxane, benzene, toluene, xylene, phenethyl alcohol, and alkanes (e.g., heptane, hexane, dodecane, and the like).

According to an embodiment of the present disclosure, the mass ratio of the ingredient of the organic portion to the ingredient of the inorganic portion can be 1:100 to 10,000:1; preferably 1:10 to 1000:1, and more preferably 1:1 to 100:1.

According to an embodiment of the present disclosure, the concentration of the metal salt solution and/or the soluble metal compound solution is 0.0001 wt % to 99.9 wt %, preferably 0.001 wt % to 50 wt %, and more preferably 0.1 wt % to 30 wt %.

According to an embodiment of the present disclosure, the precipitant is a substance capable of reacting with the metal salt solution and/or the soluble metal compound solution described above to produce a precipitate, preferably a substance capable of producing a precipitate in an aqueous solution, can be an acid, a base, an acid radical, or a complex ion, and can be selected from, for example, at least one of hydrochloric acid, oxalic acid, sulfuric acid, phosphoric acid, nitric acid, formic acid, acetic acid, citric acid, sodium hydroxide, potassium hydroxide, sodium carbonate, potassium carbonate, sodium bicarbonate, potassium bicarbonate, monosodium phosphate, monopotassium phosphate, sodium chloride, potassium chloride, ammonium chloride, sodium sulfate, potassium sulfate, ammonium sulfate, sodium nitrate, ammonium nitrate, potassium nitrate, perchloric acid, potassium permanganate, sodium permanganate, potassium dichromate, sodium dichromate, aqueous ammonia, sodium sulfide, potassium sulfide, hydrogen sulfide, hydrogen chloride, carbon dioxide, urea, thiourea, ferric chloride, ferrous chloride, sodium persulfate, potassium persulfate, or sodium citrate.

The concentration of the precipitant may be 0.0001 wt % to 99.9 wt %, preferably 0.001 wt % to 50 wt %, and more preferably 0.1 wt % to 30 wt %.

According to an embodiment of the present disclosure, a polymer is prepared first, then the polymer is used to adsorb inorganic ions, and a precipitant is optionally further added to give an inorganic-organic composite hybrid catalyst. In this reaction process, the dispersion and the particle size of the inorganic particles in the polymer are controlled by adjusting the feeding mode or the reaction conditions.

According to an embodiment of the present disclosure, the reaction conditions for controlling the dispersion and the particle size of the inorganic particles in the polymer include:

the concentration of the metal salt solution and/or the soluble metal compound solution, the ratio of these solutions to the precipitant, and the reaction temperature and reaction time. For example, the concentration of the metal salt solution and/or the soluble metal compound solution can be greater than 0 and less than the saturation concentration, and can preferably be 0.001 wt % to 50 wt %, and more preferably 0.1 wt % to 30 wt %; the ratio of the solution described above to the precipitant is 1:100 to 100:1, preferably 1:10 to 10:1; the reaction temperature is, for example, 0° C. to 210° C., preferably 30° C. to 150° C., and the reaction can be conducted in a high-pressure reaction kettle if the temperature exceeds 100° C.; the reaction time is, for example, 0.1 hours to 200 hours, preferably 0.5 hours to 48 hours.

Additionally, the feeding mode for controlling the dispersion and the particle size of the inorganic particles in the polymer can include:
(1) adding the inorganic substance to a solvent, then adding a polymer monomer and an initiator to initiate polymerization, and finally separating from the solution to give a catalyst; or
(2) adding the inorganic precursor to a solvent, then adding a polymer monomer and an initiator to initiate polymerization, then adding a substance capable of reacting with the inorganic precursor to produce a precipitate (i.e., a precipitant), and finally separating the product from the solution to give a catalyst; or
(3) adding a polymer monomer and an initiator to a solvent to initiate polymerization, then adding and dispersing the inorganic substance, and finally separating the product from the solution to give a catalyst; or
(4) adding a polymer monomer and an initiator to a solvent to initiate polymerization, then adding an inorganic precursor solution, then adding a substance capable of reacting with the inorganic precursor to produce a precipitate (i.e., a precipitant), and finally separating the product from the solution to give a catalyst; or
(5) dispersing the polymer particles in a solvent, adding and dissolving or dispersing the inorganic substance, and finally separating to give a catalyst; or
(6) dispersing the polymer particles in a solvent, adding the inorganic precursor, then adding a substance capable of reacting with the inorganic precursor to produce a precipitate (i.e., a precipitant), and finally separating the product from the solution to give a catalyst.

The inorganic substance obtained using the preparation method is dispersed, preferably as inorganic particles, on the surface of and/or inside the organic substance. The size of the inorganic particles is generally less than the volume of the organic portion, preferably not more than 10 μm, more preferably not more than 5 μm, and further preferably greater than 0 nm and not more than 1 μm.

The organic-inorganic composite catalyst described above may have various shapes such as a block shape, an irregular powder shape, a spherical shape, and a porous shape, preferably a spherical shape, and further preferably a spherical, porous shape.

The size of the organic-inorganic composite catalyst described above can be any size, and is generally greater than 0 nm and less than 10 cm; preferably not less than 10 nm and not more than 10 mm; more preferably 50 nm-100 μm; and further preferably 100 nm to 50 μm.

### [Supported Catalyst and Preparation Thereof]

The present disclosure further provides a supported catalyst comprising a support and the organic-inorganic composite catalyst described above on the support.

According to an embodiment of the present disclosure, the support preferably has a porous structure and/or a network structure, which can be shown as a macroscopic and/or microscopic framework structure, a ring structure, a fibrous structure, a net structure, or a fabric structure.

According to an embodiment of the present disclosure, the shape of the support is not particularly limited in the present disclosure and may be a known shape in the art, such as planar structures known in the art (e.g., non-woven fabric, knitted fabric, woven fabric, wire mesh, fishing net, porous membrane, sheets, or plates), and three-dimensional structures known in the art (e.g., porous microspheres, cylinders, cubes, cuboids, triangles, and strips), grids, rings, and other irregular shapes. According to an embodiment of the present disclosure, the size of the supported catalyst in any direction is preferably greater than 0.1 micrometers, further preferably less than 100 centimeters, still further preferably 1 micrometer to 10 centimeters, and even further preferably 2 micrometers to 1 centimeter, such as 10 micrometers, 50 micrometers, 100 micrometers, or 500 micrometers.

According to an embodiment of the present disclosure, the organic-inorganic composite catalyst is linked to the support by any one or more of chemical bonding, adhesive bonding, and supramolecular interaction, preferably by chemical bonding. Particularly, the support undergoes a surface reaction with a chemical group on the surface of the organic portion (especially the polymer of the organic portion) in the organic-inorganic composite catalyst described above through a chemical bond. Preferably, the surface reaction includes esterification, addition, amidation, click chemistry reactions, or other surface reactions known in the art capable of combining the organic-inorganic composite catalyst and the support.

According to an embodiment of the present disclosure, the organic-inorganic composite catalyst is distributed on the surface of the support and the inner and outer surfaces of the porous structure and/or the network structure, for example, on the surfaces of fibers, on the surfaces or in the gaps of the fibers in a fiber textile or non-woven fabric, or on the inner and outer surfaces of a framework structure or porous membrane.

According to an embodiment of the present disclosure, the mass ratio of the organic-inorganic composite catalyst to the support is greater than 0 and less than 5:1, preferably 0.0000001:1 to 1:1, more preferably 0.00001:1 to 1:10, and even more preferably 0.00001:1 to 1:100.

According to an embodiment of the present disclosure, the material of the support is selected from an inorganic material and/or a polymer material, particularly a material having a porous structure, a net structure, a framework structure, or a fabric structure. Preferably, the inorganic material is, for example, silica, aluminum oxide, rock wool, zeolite, MXene, a molecular sieve, or a metal mesh. Preferably, the polymer material is at least one of polyester fiber, nylon fiber, cotton fiber, bamboo fiber, spandex fiber, polyvinyl alcohol fiber, vinylon fiber, polyvinyl chloride fiber, and sponge. According to an embodiment of the present disclosure, the support is at least one of silica, aluminum oxide, rock wool, zeolite, MXene, a molecular sieve, or sponge which has a porous structure, or a metal mesh having a net structure, or a fibrous fabric or non-woven fabric having a framework or net structure.

According to an embodiment of the present disclosure, the support may also be selected from an aerogel, a hydrogel, and the like.

Illustratively, the support is selected from, for example, silica aerogel, phenolic aerogel, silicone sponge, polyurethane sponge, and the like.

According to an embodiment of the present disclosure, the support may also be selected from a fabric, non-woven fabric, and fibrous fabric of the polymer material.

The present disclosure further provides a preparation method for the supported catalyst comprising the following steps: dispersing the organic-inorganic composite catalyst in a solvent, adding a precursor solution of the support, and adding a reagent or a precipitant to conduct a surface reaction to cause precipitation in or solidify the precursor solution of the support to give the supported catalyst; or,
dispersing the organic-inorganic composite catalyst and a support in a solvent, and then adding an adhesive to conduct a surface reaction to give the supported catalyst; or,
dispersing the organic-inorganic composite catalyst and a support in a solvent, and conducting a surface reaction to give the supported catalyst; or,
dispersing the ingredient of the organic portion and the support in a solvent, conducting a surface reaction, then adding the ingredient of the inorganic portion, and then adding a precipitant for reaction to give the supported catalyst in situ.

According to an embodiment of the present disclosure, the precursor solution of the support refers to a solution containing the support or a solution from which the support can be prepared, and is not particularly limited in the present disclosure.

According to an embodiment of the present disclosure, the surface reaction includes esterification, addition, amidation, click chemistry reactions, or other surface reactions known in the art capable of combining the organic-inorganic composite catalyst and the support.

According to an embodiment of the present disclosure, the conditions for the surface reaction may be selected from a method known in the art, and are not particularly limited in the present disclosure.

### [Use of Organic-Inorganic Composite Catalyst or Supported Catalyst]

As mentioned above, the present disclosure further provides use of the catalyst described above in a catalytic polymerization reaction, particularly in a photoexcited catalytic polymerization reaction.

That is, the present disclosure provides a method for conducting a photoexcited catalytic polymerization reaction catalyzed by the catalyst described above.

The method for conducting a photoexcited catalytic polymerization reaction catalyzed by the catalyst described above comprises the following step:

conducting a polymerization reaction of an olefin monomer under photoexcitation conditions in the presence of the organic-inorganic composite catalyst or the supported catalyst described above.

According to an embodiment of the present disclosure, the method comprises the following steps: dispersing the organic-inorganic composite catalyst described above in an olefin monomer, and conducting a polymerization reaction of the olefin monomer under photoexcitation conditions.

According to an embodiment of the present disclosure, the method comprises the following steps:

dispersing the supported catalyst described above in an olefin monomer, and conducting a polymerization reaction of the olefin monomer under photoexcitation conditions;

or allowing an olefin monomer or a solution containing the olefin monomer to continuously flow through the supported catalyst or circularly flow through the supported catalyst, and conducting a polymerization or copolymerization reaction of the olefin monomer under photoexcitation.

It should be noted that, in the present disclosure, the catalyst is dispersed in the “olefin monomer”, and the “olefin monomer” herein includes the bulk, solutions, dispersions, emulsions, or other possible existing forms of the olefin monomer.

According to an embodiment of the present disclosure, the mass ratio of the catalyst to the olefin monomer is greater than 0, preferably 10:1 to 1:10⁸, and more preferably 1:10 to 1:10⁶.

According to an embodiment of the present disclosure, the catalyst can be dispersed in the bulk, a solution, a dispersion, or an emulsion of the olefin monomer.

According to an embodiment of the present disclosure, the polymerization reaction of the olefin monomer can be a homopolymerization reaction of monomers or a copolymerization reaction of no less than two monomers, wherein the copolymerization reaction further includes a copolymerization reaction in which after polymerization of one monomer, one or more additional monomers are added at once or successively for polymerization.

According to an embodiment of the present disclosure, the solvent used for forming the solution, dispersion, or emulsion of the olefin monomer may be water, alcohols, ketones, amides, esters, alkanes, arenes, ionic liquids, and other solvents, specifically, for example, water, ethanol, ethylene glycol, isoprene glycol, propanol, isopropanol, butanol, glycerol, pentanol, hexanol, acetone, butanone, pentanone, dimethylformamide, dimethylacetamide, dimethyl sulfoxide, tetrahydrofuran, ethyl acetate, pyrrolidine, dioxane, benzene, toluene, xylene, phenethyl alcohol, and alkanes (e.g., heptane, hexane, dodecane, and the like).

According to an embodiment of the present disclosure, the polymerization reaction of the olefin monomer can be at least one of bulk polymerization, solution polymerization, suspension polymerization, precipitation polymerization of the olefin monomer, and the like.

According to an embodiment of the present disclosure, the reaction temperature of the polymerization reaction can be room temperature, high temperature, or low temperature; preferably −80° C. to 150° C. (such as room temperature, low temperature, or high temperature), more preferably −30° C. to 100° C., further preferably −10° C. to 60° C., and still further preferably −15° C. to 40° C., i.e., room temperature (low temperature or room temperature).

According to an embodiment of the present disclosure, in the photoexcited polymerization reaction, an additional initiator may be added or not added in addition to the catalyst described above. The addition of the additional initiator can result in more complex polymers (e.g., polymers with a broader molecular weight), but preferably, no additional initiator is added.

According to an embodiment of the present disclosure, the initiator may be a photoinitiator commonly used in the art, for example, azobisisobutyronitrile, potassium persulfate, ammonium persulfate, sodium persulfate, benzoyl peroxide, 2,4,6-(trimethylbenzoyl) diphenylphosphine oxide, 2-hydroxy-2-methyl-1-[4-(2-hydroxyethoxy)phenyl]-1-acetone, methyl benzoylformate, 2-hydroxy-2-methyl-1-phenylacetone, 1-hydroxycyclohexyl phenyl ketone, or 2-methyl-2-(4-morpholinyl)-1-[4-(methylthio)phenyl]-1-acetone.

According to an embodiment of the present disclosure, the polymerization reaction can be conducted under a normal pressure, a negative pressure, or even a high pressure, and the pressure can be selected depending on the olefin monomer. Generally, a normal pressure is preferred. However, for low-boiling α-olefins such as ethylene, propylene, butene, hexene, octene, and the like, the reaction is preferably conducted under a high pressure, and the pressure is preferably 50 Pa to 100 MPa, preferably 100 Pa to 10 MPa, more preferably 1 KPa to 8 MPa, and further preferably 10 KPa to 2 MPa.

According to an embodiment of the present disclosure, the photoexcitation in the polymerization reaction includes, but is not limited to, the following excitation modes: ultraviolet light radiation, sunlight radiation, visible light radiation, infrared light radiation, X-ray radiation, and the like. the ultraviolet light radiation, visible light radiation, sunlight radiation, or X-ray radiation is preferred.

According to an embodiment of the present disclosure, specific examples of the photoexcited catalytic polymerization reaction process are as follows:

(1) The organic-inorganic composite catalyst is added to the bulk of the olefin monomer, and a photoexcitation (for example, exposure to a ultraviolet light or visible light) is performed at a temperature of −80° C. to 100° C. and under a pressure of greater than 0.5 atmospheres to give a polymerization product.

(2) The organic-inorganic composite catalyst is added to a solution of the olefin monomer, a photoexcitation (for example, exposure to a ultraviolet light or visible light) is performed at a temperature of −80° C. to 100° C. and under a pressure of greater than 0.5 atmospheres, then a poor solvent in which polymers are insoluble is added, and a precipitation is performed to give a polymerization product.

(3) The organic-inorganic composite catalyst is added to a dispersion of the olefin monomer, and a photoexcitation (for example, exposure to a ultraviolet light or visible light) is performed at a temperature of −80° C. to 100° C. and under a pressure of greater than 0.5 atmospheres to give a polymerization product.

According to an embodiment of the present disclosure, the photoexcited polymerization reaction applies to polymerization reactions of almost all olefins, and the olefin monomer in the polymerization reaction includes, but is not limited to, olefin monomers represented by formula 8 below:

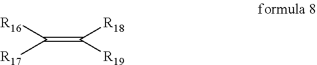

wherein R₁₆, R₁₇, R₁₈, and R₁₉ can be identical or different and are each independently R₂₀—C_{z″}H_{2z″} or R₂₀—C_{z′″}H_{2z′″-1} (z′″ is an integer greater than or equal to 0, preferably 0 to 28; z″″ is an integer greater than or equal to 1, preferably 1 to 28), and R₂₀ is absent or H, phenyl, hydroxyl, carboxyl, acylamino, an ester group, acyl chloride, cyano, C₃₋₁₈ cycloalkyl (preferably cyclopropyl, cyclobutyl, cyclopentyl, cyclohexyl, cyclooctyl, or cycloheptyl), C₃₋₁₈ cycloalkenyl (preferably cyclopropenyl, cyclobutenyl, cyclohexenyl, cyclopentenyl, or cyclopentadienyl), or

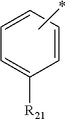

(wherein * represents a point of attachment; and R₂₁=CᵥH₂ᵥ₊₁ in which v=0-18; or C_{v′}H_{2v′-1} in which v′≥2, preferably 2 to 18).

The photoexcited polymerization reaction may also apply to monomers containing other polymerizable groups, for example: alkanes containing alkynyl, thiophene and derivatives thereof, aniline and derivatives thereof, pyrrole and derivatives thereof, cycloolefins and derivatives thereof, allylmalonic acid and derivatives thereof, cumulative dienes and derivatives thereof (e.g., allene and compounds represented by formula 9 below (wherein w′ is an integer greater than or equal to 1, preferably 1 to 18)), conjugated dienes and derivatives thereof, isolated dienes and derivatives thereof, and the like.

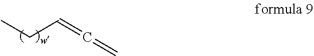

The olefin monomer specifically includes, but is not limited to, the following olefin monomers:
α-olefin monomers such as ethylene, propylene, butene, pentene, hexene, heptene, octene, nonene, decene, isobutene, isopentene, tert-pentene, isohexene, tert-hexene, neohexene, and allylcyclopentane; dienes or polyenes, cycloolefins and derivatives thereof, such as butadiene, pentadiene, decadiene, 1,2-pentadiene, 1,3-pentadiene, 1,4-pentadiene, 1,5-hexadiene, triallyl isocyanurate, 4-vinyl-1-cyclohexene, cyclohexene, cyclobutene, cyclopentadiene and derivatives thereof, dicyclopentadiene, and the like;
styrene and derivatives thereof, such as styrene, methylstyrene, dimethylstyrene, divinylbenzene, phenylpropylene, phenylpropenoic acid, 4-phenyl-1-butene, ethylstyrene, propylstyrene, butylstyrene, hydroxystyrene, trans-β-methylstyrene, carboxystyrene, and 4,4′-stilbenedicarboxylic acid;
vinyl acetate and derivatives thereof, such as vinyl acetate, vinylmethyl acetate, vinyl acetate, vinyl chloroacetate, vinyl bromoacetate, and allyl acetate;
acrylic acid and derivatives thereof, butenoic acid and derivatives thereof, pentenoic acid and derivatives thereof, hexenoic acid and derivatives thereof, and octenoic acid and derivatives thereof, preferably acrylic acid and derivatives thereof and butenoic acid and derivatives thereof, such as acrylic acid, methacrylic acid, ethylacrylic acid, propylacrylic acid, 4-hydroxybutylacrylic acid, allylmalonic acid, 2-acetaminoacrylic acid and corresponding salts thereof, butenoic acid, methylbutenoic acid, cis-2-methylbutenoic acid, 2-methyl-2-butenoic acid, 3-methyl-2-butenoic acid, 2-ethyl-2-butenoic acid, 3-butenoic acid, 2-butenoic acid, methylbutenedioic anhydride, trans-butenoic acid, 4-hydroxy-2-butenoic acid, phenyl butenoate, maleic anhydride, and 3-phenyl-2-butenoic acid;
acrylates and derivatives thereof, butenoates and derivatives thereof, pentenoates and derivatives thereof, hexenoates and derivatives thereof, and octenoates and derivatives thereof, preferably acrylates and derivatives thereof and butenoates and derivatives thereof, such as acrylates, methyl acrylate, ethyl acrylate, diethyl acrylate, hydroxyethyl acrylate, 2-(dimethylamino)ethyl acrylate, propyl acrylate, hydroxypropyl acrylate, epoxypropyl acrylate, butyl acrylate, n-butyl acrylate, isobutyl acrylate, tert-butyl acrylate, 4-hydroxybutyl acrylate, butyl 2-cyano-2-acrylate, n-pentyl acrylate, isopentyl acrylate, cyclopentyl acrylate, n-hexyl acrylate, 2-ethylhexyl acrylate, octyl acrylate, isooctyl acrylate, ethoxyethoxyethyl acrylate, β-carboxyethyl acrylate, perfluorohexylethyl acrylate, perfluorooctylethyl acrylate, 2-(perfluorohexyl)ethyl methacrylate, methacrylate, methyl methacrylate, ethyl methacrylate, propyl methacrylate, butyl methacrylate, isobutyl methacrylate, tert-butyl methacrylate, n-pentyl methacrylate, isopentyl methacrylate, hexyl methacrylate, n-hexyl methacrylate, cyclohexyl methacrylate, n-octyl methacrylate, isooctyl methacrylate, hydroxyethyl methacrylate, N-isopropyl acrylate, ethylene glycol acrylate, ethylene glycol diacrylate, ethylene glycol dimethacrylate, triethylene glycol dimethacrylate, triethylene glycol diacrylate, tetraethylene glycol diacrylate, monopolyethylene glycol acrylate, ethylene glycol methacrylate, diethylene glycol diacrylate, ethylene glycol dimethacrylate, polyethylene glycol acrylate, polyethylene glycol monoacrylate, polyethylene glycol diacrylate, polyethylene glycol methyl ether acrylate, polyethylene glycol ethyl ether acrylate, polyethylene glycol dimethyl ether acrylate, polyethylene glycol butyl ether acrylate, allyl alcohol polyoxyethylene ether, dipropylene glycol diacrylate, isoamyl 3-phenylpropenoate, glycidyl methacrylate, hydroxyethyl methacrylate, acetoacetoxyethyl methacrylate, caprolactone acrylate, trimethylolcyclohexyl acrylate, octadecyl acrylate, 4-hydroxybutyl acrylate, cyclohexyl acrylate, N,N-dimethylaminoethyl methacrylate, glycol diglycidyl ether diacrylate, hydroxyethyl methacrylate, acetoacetoxyethyl methacrylate, trimethylolpropane triacrylate, ethylene glycol dimethacrylate, ethylene glycol methacrylate, hydroxypropyl acrylate, 4-hydroxybutyl acrylate, diethyl allylmalonate, methallyl diacetate, methallyl diacetate, 4-allylpyrocatechol diacetate, 2-methallyl diacetate, methyl 2-acetaminoacrylate, ethyl 2-acetaminoacrylate, propyl 2-acetaminoacrylate, butyl 2-acetaminoacrylate, trimethylolpropane triacrylate, triallyl isocyanurate, methyl butenoate, 2-butenoate, ethyl butenoate, propyl butenoate, propyl 3-butenoate, allyl 2-butenoate, cis-butenedioates, phenyl butenoate, butyl butenoate, ethyl 3-aminobutenoate, 1-cyclohexylethyl 2-butenoate, isobutyl 2-butenoate, triethyl 4-phosphonobutenoate, and isobutyl 2-butenoate;
acrylamide and derivatives thereof, butenamide and derivatives thereof, pentenamide and derivatives thereof, pentadienamide and derivatives thereof, and hexenamide and derivatives thereof, preferably acrylamide and derivatives thereof, such as acrylamide, methacrylamide, N,N-dimethylacrylamide, N-methylolacrylamide, N-ethylacrylamide, N,N-diethylacrylamide, N-ethyl-2-methacrylamide, N-n-propylacrylamide, N-(3-methoxypropyl)acrylamide, N-(2-hydroxypropyl)acrylamide, N-isopropylacrylamide, N-isopropylmethacrylamide, cyclopropylmethacrylamide, N-[(3-dimethylamino)propyl]acrylamide, dimethylaminopropylmethacrylamide, N-butylacrylamide, N-isobutylacrylamide, N-(1,1-dimethyl-3-oxobutyl)acrylamide, N-tert-butylacrylamide, N-butoxymethacrylamide, N-(isobutoxymethyl)acrylamide, N,N-dibutylacrylamide, 4-hydroxybutylacrylamide, N-pentylacrylamide, pentylbenzamide, cyclopentylacrylamide, N-n-hexylacrylamide, N-hexylhydroxamic acid acrylamide, N-cyclohexylacrylamide, N-n-octylacrylamide, N-tert-octylacrylamide, N-dodecylacrylamide, N,N′-methylenebisacrylamide, N,N′-(1,2-dihydroxyethylene)bisacrylamide, N,N-bis(2-hydroxyethyl)methacrylamide, N-(2-hydroxypropyl)methacrylamide, 2-methyl-N-(2-phenylethyl)-2-acrylamide, N-(p-hydroxyphenyl)methacrylamide, N-cyclopropylmethacrylamide, N-pyrrolidinylacrylamide, α-bromoacrylamide and derivatives thereof, N,N-diglycidylacrylamide, N,N-diglycidylmethacrylamide, N-(4-epoxypropoxybutyl)acrylamide, N-(4-epoxypropoxybutyl)methacrylamide, N-(5-epoxypropoxypentyl)acrylamide, 4-methyl-2-pentenamide, N-benzyl-4-chloro-N-isobutyl-2-pentenamide, N-methoxy-4-pentenamide, N-ethoxy-4-pentenamide, N-propoxy-4-pentenamide, N-butoxy-4-pentenamide, (2S,4E)-5-chloro-N,N-dimethyl-2-isopropyl-4-pentenamide, N-ethyl E2,E4-hexadienamide, N-cyclopropyl E2,E4-hexadienamide, 3,7-dimethyl-2,6-octadienamide, N,N-diethenylethenamine, 2-octen-4,6-diynamide, N-(1-naphthyl)acrylamide, N-methylolacrylamide, N-hydroxyethylacrylamide, diacetone acrylamide, acrylamide, N,N′-methylenebisacrylamide, N,N′-methylenebisacrylamide, acrylate N-hydroxyethyl acrylamide; and
olefin monomers containing siloxanyl, such as vinylmethyldiethoxysilane, vinyltriethoxysilane, tert-butenoyloxyethoxysilane, vinyltriacetoxysilane, allyltriethoxysilane, tetrakis (acryloxyethoxy) silane, γ-(methacryloxy) propyltrimethoxysilane, vinyltris (β-methacryloxypropylmethyldiethoxysilane, methoxyethoxy) silane, and the like.

The monomers containing other polymerizable groups specifically include, but are not limited to, the following monomers that can undergo radical polymerization, such as: vinylpyridine, thiophene and derivatives thereof, pyrrole and derivatives thereof, aniline and derivatives thereof, acetylene, propyne, propargyl cyanide, diarylethene, diallyldimethylammonium chloride, allylmalonic acid, and the like.

### [Polymer and Use Thereof]

The present disclosure further provides a polymer obtained using the method described above.

According to an embodiment of the present disclosure, the polymer has controllable molecular weight distribution and a color-changing property. For example, the molecular weight distribution of the polymer can be varied in the range of 500 to 2,000,000, and further can be varied in the range of 1000 to 1,000,000; PDI can be 1 to 10, preferably 1 to 4, and more preferably 1 to 2. The color-changing property means that it can change from colorless, white, or pale yellow to blue, red, or green under visible light or ultraviolet light.

The present disclosure further provides use of the polymer described above in color-changing fibers, color-changing sheets, color-changing membranes, color-changing inks, color-changing toners, color-changing adhesives, color-changing energy-saving windows, camouflage, and anti-counterfeiting.

The technical solutions of the present disclosure will be further described in detail with reference to the following specific examples. It should be understood that the following examples are merely exemplary illustration and explanation of the present disclosure and should not be construed as limiting the protection scope of the present disclosure. All techniques implemented based on the content described above of the present disclosure are encompassed within the protection scope of the present disclosure.

Unless otherwise stated, the starting materials and reagents used in the following examples are all commercially available products or can be prepared by using known methods.

### 1. CATALYST PREPARATION EXAMPLES

### Example 1

### Preparation of Sodium Molybdate-Ferric Chloride/Polyacrylamide Catalyst Particles

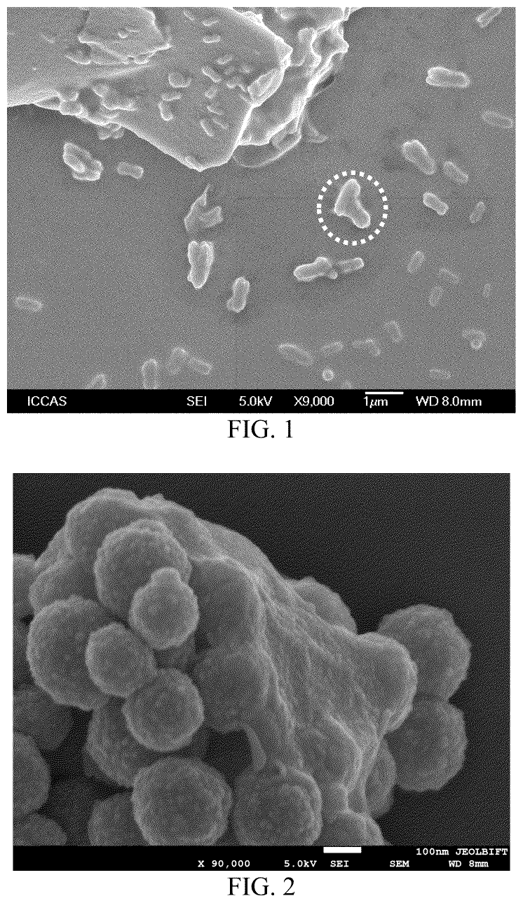

In a 50 mL flask, 20 mL of an aqueous solution of 0.1 g of polyacrylamide was added, 5 mL of a 1 M (3.6%) sodium molybdate solution and a 0.1 M ferric chloride solution were added. After stirring for 90 min, the mixture was subjected to a centrifugal separation, drying, and crushing to give sodium molybdate-ferric chloride-loaded catalyst particles. (The size of the catalyst was about 0.1 to 5 mm, and the size of the inorganic particles in the catalyst was 0.1 μm to 8 μm. See FIG. 1.) As can be seen from FIG. 1, the inorganic particles can have a spherical shape.

### Example 1A

100 mL of toluene was taken, 5 g of porous silica was added, and 0.5 g of 3-(2,3-epoxypropoxy) propyltrimethoxysilane was then added. The mixture was left to react for 3 hours and then subjected to separation and drying to give a treated support. 1 g of the catalyst in Example 1 was taken, and 10 mL of heptane and 5 g of the treated support described above were then added. The mixture was heated at 60° C. for 2 hours to give a supported catalyst. The mass ratio of the catalyst particles to the support was 1:5. Characterization showed that the silica support had a rough surface, indicating a silica-supported catalyst.

### Example 2

### Preparation of Ammonium Molybdate/Poly(Acrylamide-N,N′-Methylenebisacrylamide) Catalyst Particles

3 g of acrylamide and 0.6 g of N,N′-methylenebisacrylamide were added to 500 mL of water, and 0.02 g of ammonium persulfate was then added. After charging nitrogen gas, the mixture was heated to 70° C. and left to react for 3 hours to give a gel. The gel was taken out, washed with clean water, dried, and crushed. The resulting poly(acrylamide-N,N′-methylenebisacrylamide) particles were added to a solution of 2 g of ammonium molybdate in 100 mL of water. After stirring for 30 minutes, 10 ml of 10 M (36%) hydrochloric acid was added. After reacting for 1 hour, the reaction mixture was subjected to a centrifugal separation, washed thoroughly with water, and dried to give catalyst particles. (The size of the catalyst was about 1 mm to 5 mm, and the size of the inorganic particles in the catalyst was 3 μm to 9 μm.)

### Example 2A

### Preparation of Ammonium Molybdate/Poly(Acrylamide-N,N′-Methylenebisacrylamide) Composite Particle Supported Catalyst

The catalyst particles of Example 2 were added to heptane, 100 g of cotton fibrous fabric was then added, and 0.1 g of epoxy resin was then added. The mixture was left to react at room temperature for 4 hours, and the fibrous fabric was then taken out, washed with ethanol, and dried to give an organic-inorganic composite particle supported catalyst. The mass ratio of the catalyst particles to the support was 1:30.

### Example 3

### Preparation of Tungsten Oxide/Poly(Acrylamide-N,N′-Methylenebisacrylamide) Catalyst Particles

2 g of potassium tungstate, 3 g of acrylamide, and 0.6 g of N,N′-methylenebisacrylamide were added to 500 mL of water, and 0.02 g of ammonium persulfate was then added. After charging nitrogen gas, the mixture was heated to 70° C. and left to react for 3 hours. The product was added to 500 mL of a 1% sulfuric acid solution, and the mixture was left to react at 90° C. for 1 hour. The product was taken out, washed with clean water, dried, and crushed to give catalyst particles of about 1 mm to 20 mm (the size of the inorganic particles in the catalyst was 1 nm to 20 nm).

### Example 3A

1 g of the tungsten oxide/poly(acrylamide-N,N′-methylenebisacrylamide) catalyst particles in Example 3 was dispersed in 100 mL of ethanol, 100 g of zeolite support was then added, and 1 g of glycidyl methacrylate was then added. The mixture was left to fully react for 3 hours, and the zeolite was taken out and washed with ethanol and water to give a supported catalyst. The mass ratio of the catalyst particles to the support was 1:200.

### Example 4

### Preparation of Tungsten Oxide/Poly(Acrylamide-N-Isopropylacrylamide-N,N′-Methylenebisacrylamide) Catalyst Particles

0.3 g of acrylamide, 1 g of N-isopropylacrylamide, 0.2 g of N,N′-methylenebisacrylamide, 0.005 g of potassium tungstate, and the like were added to 1 L of water, and 0.02 g of potassium persulfate was then added. After charging nitrogen gas, the mixture was heated to 70° C. and left to react for 2 hours, and 10 mL of 0.1 M (0.36%) hydrochloric acid was then added. The mixture was left to react for additional 3 hours, and the particles were taken out, washed, and dried to give catalyst particles. (The size of the catalyst was about 0.1 μm to 1 μm, and the size of the inorganic particles in the catalyst was 20 nm to 200 nm. See FIG. 2.)

### Example 5

### Preparation of Tungsten Oxide/Poly(N-Isopropylacrylamide-N,N′-Methylenebisacrylamide) Catalyst Particles

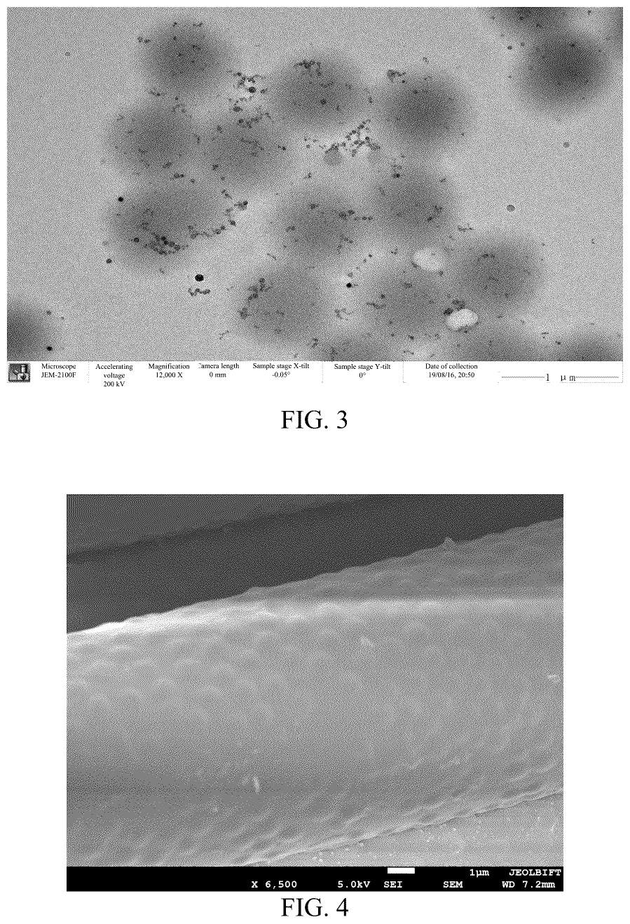

1 g of poly(N-isopropylacrylamide-N,N′-methylenebisacrylamide) particles was added to 1 L of water, and 0.1 g of sodium tungstate and 10 mL of 0.1 M (0.36%) hydrochloric acid were then added. After charging nitrogen gas, the mixture was heated to 70° C. and left to react for 12 hours, and the particles were taken out, washed, and dried to give catalyst particles. (The size of the catalyst was about 100 nm to 500 nm, and the size of the inorganic particles in the catalyst was 1 nm to 50 nm. See FIG. 3.) Example 5A

The catalyst particles of Example 5 were dispersed in water, 0.2 g of 1-(3-dimethylaminopropyl)-3-ethylcarbodiimide hydrochloride and 0.2 g of N-hydroxysuccinimide were added, and a polyester fiber fabric containing amino on the surface was then added. The mixture was left to react at 20° C. to 70° C. for 6 hours, and the polyester fiber fabric was taken out to give a supported catalyst. The mass ratio of the catalyst particles to the polyester fiber fabric was 1:1000. The morphology was shown in FIG. 4.

### Example 6

### Preparation of Sodium Tungstate/Poly(N-Isopropylacrylamide-Acrylamide-N,N′-Methylenebisacrylamide)-Chitosan Catalyst Particles

5 g of acrylamide, 1 g of N-isopropylacrylamide, 1 g of N,N′-methylenebisacrylamide, 0.2 g of sodium tungstate, and 0.1 g of chitosan were added to 1 L of water, and 0.02 g of ammonium persulfate and 1 mL of 0.1 M (0.36%) hydrochloric acid were then added. After charging nitrogen gas, the mixture was heated to 70° C. and left to react for 3 hours to give a gel. The gel was taken out, washed, dried, and crushed to give catalyst particles. (The size of the catalyst was about 1 μm to 10 μm, and the size of the inorganic particles in the catalyst was 100 nm to 500 nm.)

### Example 7

Preparation of Tungsten Oxide-Molybdenum Oxide/Poly(N-Isopropylacrylamide-N,N′-Methylenebisacrylamide-acrylic acid) catalyst particles

In a 500 mL flask, 10 g of poly(N-isopropylacrylamide-N,N′-methylenebisacrylamide-acrylic acid) particles was added, and 1 L of water was added. After the particles were fully dispersed, 1 g of potassium tungstate and 1 g of sodium molybdate were added. After stirring for 1 hour, 10 mL of 10 M (36%) hydrochloric acid was added. After reacting for 10 hours, the reaction mixture was subjected to a centrifugal separation, washed thoroughly with water, and dried to give catalyst particles. (The size of the catalyst was about 100 nm to 500 nm, and the size of the inorganic particles in the catalyst was 10 nm to 50 nm.)

### Example 7A

The catalyst particles of Example 7 were added to ethanol, 0.1 square meters of polyurethane non-woven fabric was added, and 10 g of glycidyl methacrylate was then added. The mixture was left to fully react for 6 hours to give a supported catalyst. The mass ratio of the catalyst particles to the polyurethane non-woven fabric was 1:1000.

### Example 8

### Preparation of Phosphotungstic Acid/Poly(Acrylamide-N-Isopropylacrylamide-Divinylbenzene) Catalyst Particles

1 g of acrylamide, 0.5 g of divinylbenzene, 2 g of N-isopropylacrylamide, and 0.2 g of phosphotungstic acid were added to 500 mL of water, and 0.01 g of ammonium persulfate was then added. After charging nitrogen gas, the mixture was heated to 70° C. and left to react for 3 hours, and the reaction mixture was centrifuged, washed, dried, and crushed to give catalyst particles. (The particle size was about 50 nm to 1000 nm, and the size of the inorganic particles in the catalyst was 5 nm to 100 nm.)

### Example 8A

The catalyst particles of Example 8 were added to ethanol, 0.1 square meters of glass wire mesh was added, and 5 g of γ-glycidoxypropyltrimethoxysilane and 5 g of glycidyl methacrylate were then added. The mixture was left to fully react for 6 hours to give a supported catalyst. The mass ratio of the catalyst particles to the glass wire mesh was 1:10000.

### Example 9

### Preparation of Zinc Oxide-Phosphomolybdic Acid/Poly(Methyl Acrylate-N-Isopropylacrylamide-Ethylene Glycol Dimethacrylate) Catalyst Particles

1 g of methyl acrylate, 0.5 g of ethylene glycol dimethacrylate, 2 g of N-isopropylacrylamide, 0.2 g of phosphomolybdic acid, and 0.1 g of zinc oxide were added to 500 ml of water, and 0.01 g of ammonium persulfate was then added. After charging nitrogen gas, the mixture was heated to 70° C. and left to react for 3 hours, and the reaction mixture was centrifuged, washed, dried, and crushed to give catalyst particles. (The size of the catalyst was about 10 nm to 300 nm, and the size of the inorganic particles in the catalyst was 5 nm to 30 nm.)

### Example 10

### Preparation of Cesium Phosphotungstate/Poly(N-Isopropylacrylamide-Methylolacrylamide-Dimethylstyrene) Catalyst Particles

1 g of N-isopropylacrylamide, 0.2 g of dimethylstyrene, 0.5 g of methylolacrylamide, and 0.2 g of phosphotungstic acid were added to 500 mL of water, and 0.1 g of potassium persulfate was then added. After charging nitrogen gas, the mixture was heated to 70° C. and left to react for 3 hours. Then 50 mL of a 0.3 M aqueous cesium chloride solution was added, and the mixture was left to react at 90° C. for 1 hour. Then the reaction mixture was centrifuged, washed, and dried to give catalyst particles. (The size of the catalyst was about 50 nm to 300 nm, and the size of the inorganic particles in the catalyst was 5 nm to 60 nm.)

### Example 11

### Preparation of Uranium Oxide/Poly(Methyl Acrylate-Ethylene Glycol Dimethacrylate) Catalyst Particles

10 g of methyl acrylate, 2 g of ethylene glycol dimethacrylate, and 0.1 g of uranium trichloride were added to 500 mL of water, and 0.1 g of potassium persulfate was then added. After charging nitrogen gas, the mixture was heated to 70° C. and left to react for 3 hours. Then a 5% aqueous ammonia solution was added, and the mixture was left to react at 90° C. for 1 hour. Then the reaction mixture was centrifuged, washed, and dried to give catalyst particles. (The size of the catalyst was about 100 nm to 1000 nm, and the size of the inorganic particles in the catalyst was 5 nm to 40 nm.)

### Example 12

### Preparation of Cadmium Sulfide/Poly(2-Ethyl-2-Butenoic Acid-Triallyl Isocyanurate) Catalyst Particles

1 g of 2-ethyl-2-butenoic acid, 0.2 g of triallyl isocyanurate, and 0.1 g of cadmium nitrate were added to 500 ml of water, and 0.1 g of sodium persulfate was then added. After charging nitrogen gas, the mixture was heated to 70° C. and left to react for 3 hours. Then 10 mL of a 5% aqueous thiourea solution was added, and the mixture was left to react at 90° C. for 1 hour. Then the reaction mixture was centrifuged, washed, and dried to give catalyst particles. (The size of the catalyst was about 50 nm to 200 nm, and the size of the inorganic particles in the catalyst was 5 nm to 60 nm.)

### Example 13

### Preparation of Zinc Oxide/Poly(Acrylamide-Triallyl Isocyanurate) Catalyst Particles

0.1 g of zinc acetate was added to ethanol, and 10 g of acrylamide and 1 g of triallyl isocyanurate were added to ethanol. The mixture was left to react at 50° C. for 6 hours. Then 1 mL of a 5% aqueous ammonia solution was added, and the mixture was left to react at 50° C. for additional 3 hours. The reaction mixture was centrifuged, washed, and dried to give a catalyst. (The particle size was about 100 nm-1 μm, and the size of the inorganic particles in the catalyst was 5 nm to 200 nm.)

### 2. POLYMERIZATION REACTION EXAMPLES

### Example 14

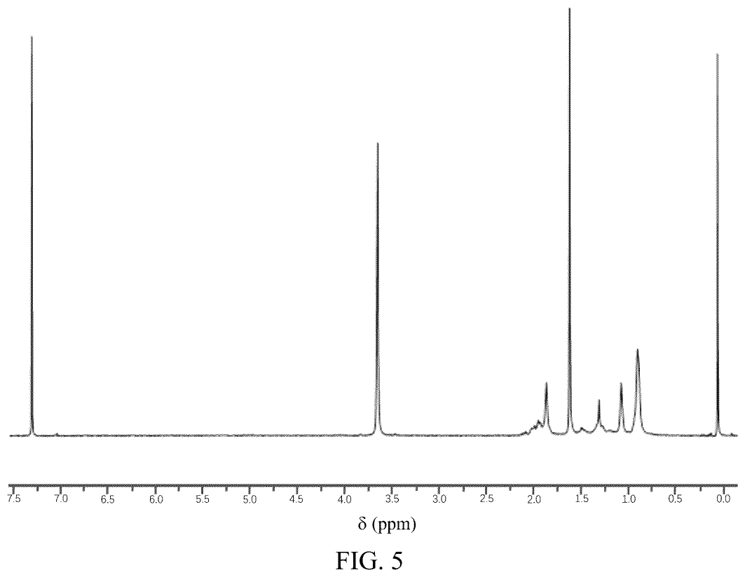

0.05 g of the catalyst particles of Example 1 was dispersed in 500 mL of a toluene solution containing 0.01 g of azobisisobutyronitrile and 1 g of octene, and nitrogen gas was charged for 30 minutes. While being stirred, the mixture was exposed to a 12-watt ultraviolet lamp at room temperature for 36 hours, and ethanol was then added for precipitation to give polyoctene (see the nuclear magnetic resonance spectrum of FIG. 5; the molecular weight was about 100,000).

### Example 14A

0.2 g of the supported catalyst of Example 1A was added to 50 mL of toluene, and 1 g of styrene monomer was added. The mixture was exposed to ultraviolet light to give polystyrene (the molecular weight was about 200,000).

### Example 15

0.2 g of the catalyst particles of Example 2 was dispersed in 100 ml of water containing 0.005 g of potassium persulfate. After charging nitrogen gas for 30 minutes, gas was evacuated from the flask, and propylene gas was then continuously introduced. The mixture was exposed to a 12-watt ultraviolet lamp for 5 hours, and ethanol was then added for precipitation to give polypropylene particles (the molecular weight was about 60,000).

### Example 15A

0.5 g of the supported catalyst of Example 2A was dispersed in 500 mL of a toluene solution containing 0.01 g of azobisisobutyronitrile and 1 g of octene, and nitrogen gas was charged for 30 minutes. While being stirred, the mixture was exposed to a 12-watt ultraviolet lamp at room temperature for 36 hours, and ethanol was then added for precipitation to give polyoctene (the molecular weight was about 100,000).

### Example 16

0.5 g of the catalyst particles of Example 2 was dispersed in 50 mL of water. After charging nitrogen gas for 30 minutes, gas was evacuated from the flask, and ethylene gas was then continuously introduced. The mixture was exposed to a 12-watt ultraviolet lamp for 5 hours, and ethanol was then added for precipitation to give polyethylene particles.

### Example 17

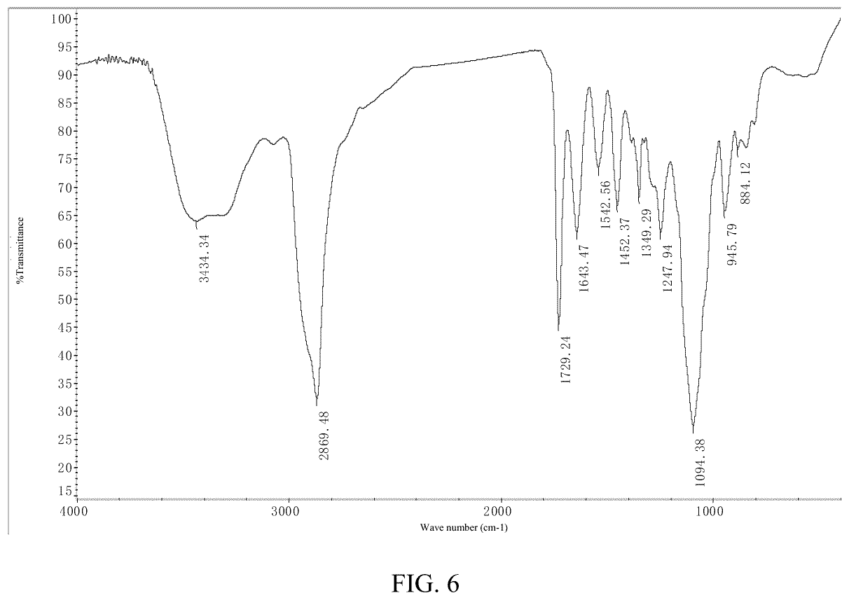

0.5 g of the catalyst particles of Example 4 was dispersed in 50 mL of water. After charging nitrogen gas for 30 minutes, gas was evacuated from the flask, and propylene gas was then continuously introduced. The mixture was exposed to a 12-watt ultraviolet lamp for 5 hours, and ethanol was then added for precipitation to give polypropylene particles (see the infrared spectrum of FIG. 6).

### Example 18

0.01 g of the catalyst particles of Example 5 was dispersed in 500 mL of dimethyl sulfoxide containing 10 g of methyl methacrylate. The mixture was exposed to a 3-watt ultraviolet lamp for 5 hours, and ethanol was then added for precipitation to give polymethyl methacrylate (the molecular weight was about 60,000).

### Example 18A

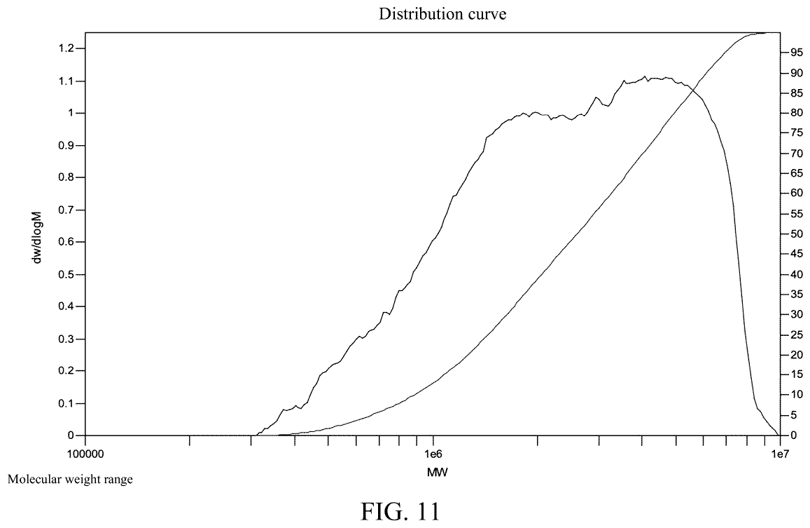

1 g of the supported catalyst of Example 5A was placed in 100 mL of toluene. After charging nitrogen gas for 30 minutes, gas was evacuated from the flask, and 5 g of methyl methacrylate was then added. The mixture was exposed to a 12-watt ultraviolet lamp for 24 hours to give a polymethyl methacrylate polymer with ultra-high molecular weight (the molecular weight was 3,060,000, as shown in FIG. 11).

### Example 19

0.01 g of the catalyst particles of Example 5 was dispersed in 500 mL of a N,N-dimethylacetamide solution containing 10 g of styrene. The mixture was exposed to a 3-watt ultraviolet lamp for 5 hours, and ethanol was then added for precipitation to give polystyrene particles (the molecular weight was about 5000).

### Example 20

0.01 g of the catalyst particles of Example 6 was dispersed in 500 mL of an aqueous solution containing 1 g of N-isopropylacrylamide and 0.2 g of N,N′-methylenebisacrylamide. After charging nitrogen gas for 30 minutes, the mixture was exposed to a 3-watt ultraviolet lamp for 5 hours, and the reaction mixture was then subjected to a centrifugal separation to give poly(N-isopropylacrylamide-N,N′-methylenebisacrylamide) polymer particles (cross-linked polymer particles).

### Example 20A

1 g of the supported catalyst particles of Example 7A was dispersed in 500 mL of an aqueous solution containing 2 g of acrylamide and 0.2 g of N,N′-methylenebisacrylamide, and the mixture was exposed to a 3-watt ultraviolet lamp for 5 hours to give polyacrylamide (the molecular weight was 600,000).

### Example 20B

1 g of the supported catalyst particles of Example 7A was dispersed in 500 mL of ethanol, and 10 g of methyl methacrylate was added. The mixture was exposed to a 12-watt ultraviolet lamp for 5 hours to give polymethyl methacrylate.

### Example 21

0.01 g of the catalyst particles of Example 6 was dispersed in 500 mL of a tetrahydrofuran solution containing 1 g of glycidyl methacrylate. After charging nitrogen gas for 30 minutes, the mixture was exposed to a 24-watt ultraviolet lamp for 5 hours, and the reaction mixture was subjected to a centrifugal separation to give a poly(glycidyl methacrylate) polymer (the molecular weight was about 1,000,000).

### Example 22

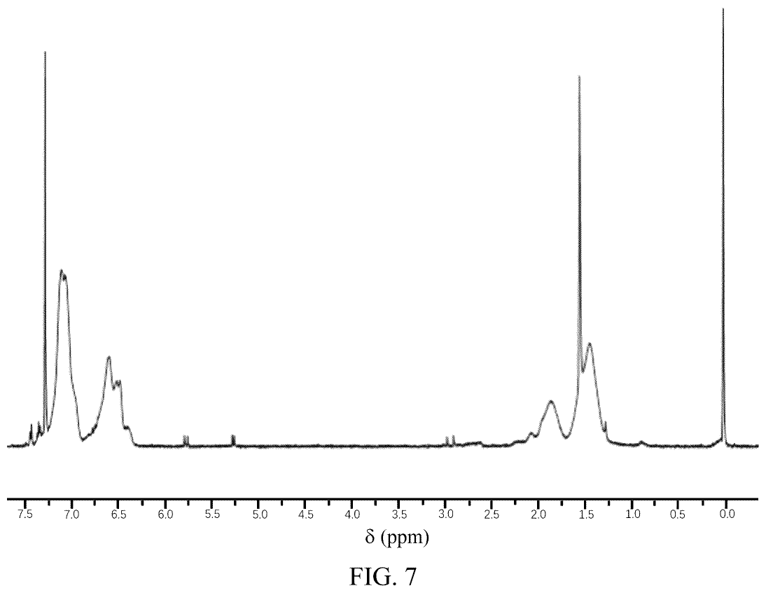

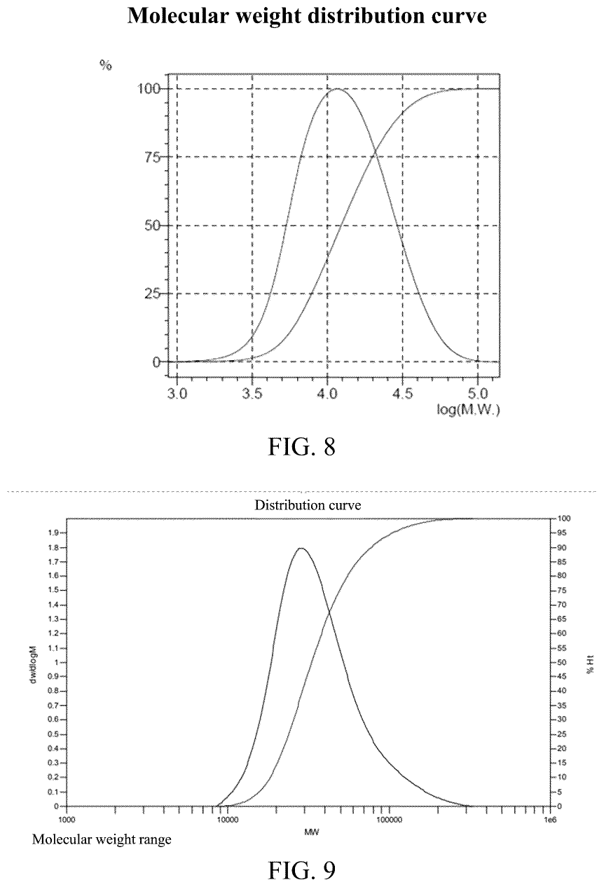

0.1 g of the catalyst particles of Example 3 was dispersed in 250 mL of a tetrahydrofuran solution containing 0.005 g of benzoyl peroxide and 5 g of styrene, and nitrogen gas was charged for 30 minutes. While being stirred, the mixture was exposed to sunlight at 40° C. for 8 hours, and ethanol was added for precipitation to give polystyrene (see the nuclear magnetic resonance spectrum of FIG. 7 and the molecular weight distribution curve of FIG. 8; the molecular weight was about 40,000). As can be seen from FIGS. 7 and 8, polystyrene with a narrow molecular weight distribution (PDI=1.5) was obtained.

### Example 22A

2 g of the supported catalyst of Example 3A was dispersed in 100 mL of ethanol. After charging nitrogen gas for 30 minutes, gas was evacuated from the flask, and 5 g of styrene was then continuously added. The mixture was exposed to a 12-watt ultraviolet lamp for 5 hours to give polystyrene particles (the molecular weight was about 200,000).

### Example 23

0.1 g of the catalyst particles of Example 3 was dispersed in 250 mL of a tetrahydrofuran solution containing 5 g of p-methylstyrene, and nitrogen gas was charged for 30 minutes. While being stirred, the mixture was exposed to sunlight at 40° C. for 8 hours, and ethanol was added for precipitation to give poly(p-methylstyrene) (the molecular weight was about 50,000).

### Example 24

0.01 g of the catalyst particles of Example 4 was dispersed in 500 mL of an aqueous solution containing 5 g of acrylamide, and nitrogen gas was charged for 30 minutes. While being stirred, the mixture was exposed to an X-ray light at 0° C. for 12 hours to give a polyacrylamide gel (the molecular weight was about 100,000).

### Example 25

0.002 g of the catalyst particles of Example 5 was dispersed in 500 mL of an aqueous solution containing 1 g of methyl methacrylate and 0.1 g of sodium dodecyl sulfate, and nitrogen gas was charged for 30 minutes. While being stirred, the mixture was exposed to a 3-watt ultraviolet lamp at room temperature for 36 hours to give polymethyl methacrylate (see the molecular weight distribution curve of FIG. 9; the molecular weight was about 30,000).

### Example 26

0.002 g of the catalyst particles of Example 9 was dispersed in 250 mL of an aqueous solution containing 0.5 g of N-isopropylacrylamide, and nitrogen gas was charged for 30 minutes. While being stirred, the mixture was exposed to a 3-watt ultraviolet lamp at 5° C. for 36 hours to give poly(N-isopropylacrylamide) (the molecular weight was about 60,000).

### Example 27

0.002 g of the catalyst particles of Example 10 was dispersed in 250 mL of a toluene solution containing 2 g of propyl 3-butenoate, and nitrogen gas was charged for 30 minutes. While being stirred, the mixture was exposed to a 3-watt ultraviolet lamp at 80° C. for 36 hours to give polypropyl 3-butenoate (the molecular weight was about 60,000).

### Example 28

0.002 g of the catalyst particles of Example 6 was dispersed in 1000 mL of a N,N-dimethylformamide solution containing 200 g of vinyl acetate, and nitrogen gas was charged for 30 minutes. While being stirred, the mixture was exposed to a 12-watt ultraviolet lamp at room temperature for 36 hours, and water was then added for precipitation to give polyvinyl acetate (the molecular weight was about 60,000).

### Example 29

0.05 g of the catalyst particles of Example 11 was dispersed in 2,500 mL of a toluene solution containing 200 g of acrylic acid and 0.5 g of divinylbenzene, and nitrogen gas was charged for 30 minutes. While being stirred, the mixture was exposed to a 12-watt ultraviolet lamp at room temperature for 36 hours to give poly(acrylic acid-divinylbenzene) particles (the molecular weight was about 10,000).

### Example 30

0.05 g of the catalyst particles of Example 12 was dispersed in 1000 mL of a tetrahydrofuran solution containing 200 g of polyethylene glycol acrylate, and nitrogen gas was charged for 30 minutes. While being stirred, the mixture was exposed to a 12-watt ultraviolet lamp at 40° C. for 6 hours to give poly(polyethylene glycol acrylate) particles (the molecular weight was about 100,000).

### Example 31

0.05 g of the catalyst particles of Example 8 was dispersed in 100 mL of an ethanol solution containing 2 g of methyl methacrylate, and nitrogen gas was charged for 30 minutes. While being stirred, the mixture was exposed to a 12-watt ultraviolet lamp at 20° C. for 36 hours to give poly(methyl methacrylate). The reaction mixture was filtered and washed to give the polymer (the molecular weight was 80,000).

### Example 31A

1 g of the supported catalyst of Example 8A was dispersed in 100 mL of water. After charging nitrogen gas for 30 minutes, 10 g of ethylene vinyl acetate was added, and the mixture was exposed to a 12-watt ultraviolet lamp for 5 hours to give polyethylene vinyl acetate.

### Example 32

0.001 g of the catalyst particles of Example 9 was dispersed in 200 mL of an ethanol solution containing 2 g of vinyltriacetoxysilane, and nitrogen gas was charged for 30 minutes. While being stirred, the mixture was exposed to a 12-watt ultraviolet lamp at 60° C. for 12 hours to give poly(vinyltriacetoxysilane). The reaction mixture was filtered and washed to give the polymer.

### Example 33

0.01 g of the catalyst particles of Example 4 was dispersed in 500 mL of a N,N-dimethylacetamide solution containing 3 g of styrene and 3 g of acrylamide. The mixture was exposed to a 3-watt ultraviolet lamp for 5 hours, and ethanol was then added for precipitation to give a poly(styrene-acrylamide) copolymer (the molecular weight was about 5,000).

### Example 34

0.01 g of the catalyst particles of Example 5 was dispersed in 500 mL of a tetrahydrofuran solution containing 5 g of methyl methacrylate. The mixture was exposed to a 3-watt ultraviolet lamp for 5 hours, and 3 g of styrene was then added. The polymerization reaction was continued for additional 10 hours, and ethanol was added for precipitation to give a polymethyl methacrylate-polystyrene copolymer.

### 3. TESTING OF POLYMER'S COLOR-CHANGING PROPERTY

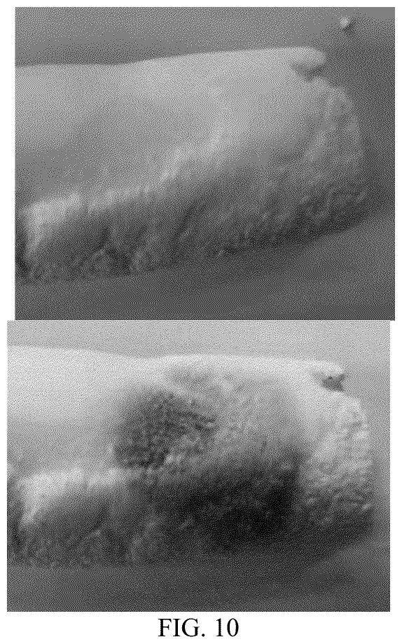

The polymer of Example 25 was exposed to a ultraviolet lamp of a portable ultraviolet detector ZF-7A for ten minutes. As shown in FIG. 10, the color of the polymer visibly changed.

The embodiments of the present disclosure have been described above. However, the present disclosure is not limited to the embodiments described above. Any modification, equivalent replacement, improvement, and the like made without departing from the spirit and principle of the present disclosure shall fall within the protection scope of the present disclosure.

1. A method for conducting a photoexcited catalytic polymerization reaction catalyzed by an organic-inorganic composite catalyst, comprising the following steps:
dispersing the organic-inorganic composite catalyst in an olefin monomer, and conducting a polymerization reaction of the olefin monomer under photoexcitation conditions,
wherein the organic-inorganic composite catalyst comprises an organic portion and an inorganic portion, wherein the inorganic portion is dispersed in the form of inorganic particles on a surface of and/or inside the organic portion, and the inorganic particles have a size of not more than 100 μm.

2. The method according to claim 1, wherein in the organic-inorganic composite catalyst, an ingredient of the organic portion is selected from, for example, a polymer, including, but not limited to: a homopolymer of an olefin monomer containing acylamino, carboxyl, hydroxyl, or an ester group; a copolymer of no less than two olefin monomers containing acylamino, carboxyl, hydroxyl, or an ester group; or a cross-linked polymer formed from no less than one olefin monomer containing acylamino, carboxyl, hydroxyl, or an ester group and a cross-linking agent; or a copolymer of no less than one olefin monomer containing acylamino, carboxyl, hydroxyl, or an ester group with an additional monomer; or derivatives obtained by further reacting the polymers described above.

3. The method according to claim 1, wherein in the organic-inorganic composite catalyst, an ingredient of the inorganic portion is selected from, for example, inorganic substances containing a metal element, wherein the metal element includes at least a metal element having a variable valence characteristic, for example, at least one metal selected from tungsten, molybdenum, scandium, rhodium, vanadium, aluminum, manganese, iridium, osmium, ruthenium, europium, terbium, cerium, yttrium, and uranium, and further includes at least one element selected from chromium, zinc, cadmium, phosphorus, sulfur, neodymium, thorium, strontium, gallium, indium, and the like;
preferably, a mass ratio of the organic portion to the inorganic portion can be 1:100 to 10,000:1, preferably 1:10 to 1000:1, and more preferably 1:1 to 100:1.

4. The method according to claim 1, wherein a mass ratio of the catalyst to the olefin monomer is greater than 0, preferably 10:1 to 1:10⁸, and more preferably 1:10 to 1:10⁶.

5. The method according to claim 1, wherein the olefin monomer in the polymerization reaction includes, but is not limited to, olefin monomers represented by formula 8 below: 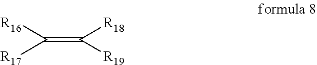
wherein R₁₆, R₁₇, R₁₈, and R₁₉ can be identical or different and are each independently R₂₀—C_{z′″}H_{2z′″} or R₂₀—C_{z″″}H_{2z″″-1} (z′″ is an integer greater than or equal to 0, preferably 0 to 28; z″″ is an integer greater than or equal to 1, preferably 1 to 28), and R₂₀ is absent or H, phenyl, hydroxyl, carboxyl, acylamino, an ester group, acyl chloride, cyano, C₃₋₁₈ cycloalkyl (preferably cyclopropyl, cyclobutyl, cyclopentyl, cyclohexyl, cyclooctyl, or cycloheptyl), C₃₋₁₈ cycloalkenyl (preferably cyclopropenyl, cyclobutenyl, cyclohexenyl, cyclopentenyl, or cyclopentadienyl), or 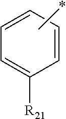
(wherein * represents a point of attachment; and R₂₁=CᵥH₂ᵥ₊₁ in which v=0-18; or C_{v′}H_{2v′-1} in which v′≥2, preferably 2 to 18).

6. A polymer obtained using the method according to claim 1.

7. Use of the polymer according to claim 6 in color-changing fibers, color-changing sheets, color-changing membranes, color-changing inks, color-changing toners, color-changing adhesives, color-changing energy-saving windows, camouflage, and anti-counterfeiting.

8. An organic-inorganic composite catalyst, comprising an organic portion and an inorganic portion, wherein the inorganic portion is dispersed in the form of inorganic particles on a surface of and/or inside the organic portion, and the inorganic particles have a size of not more than 100 μm.

9. A supported catalyst, comprising a support and the organic-inorganic composite catalyst according to claim 8 on the support.

10. Use of the organic-inorganic composite catalyst according to claim 8 in a photocatalytic polymerization reaction, particularly in a photocatalytic living polymerization reaction.

11. Use of the supported catalyst according to claim 9 in a photocatalytic polymerization reaction, particularly in a photocatalytic living polymerization reaction.
